(19) United States
(12) Patent Application Publication
(10) Pub. No.: US 2024/0100950 A1
(43) Pub. Date: Mar. 28, 2024

(54) Systems And Methods For A Vehicle Interactive Display

(71) Applicant: Fisker Inc., Manhattan Beach, CA (US)

(72) Inventors: Chip Alexander, Manhattan Beach, CA (US); Todd Omotani, Manhattan Beach, CA (US); Wyatt Coe, Manhattan Beach, CA (US)

(21) Appl. No.: 18/472,957

(22) Filed: Sep. 22, 2023

Related U.S. Application Data
(60) Provisional application No. 63/377,101, filed on Sep. 26, 2022.

(51) Int. Cl. B60K 35/00

(52) U.S. Cl. CPC B60K 35/00; B60K 2370/11; B60K 2370/152; B60K 2370/48; B60K 2370/797

(57) ABSTRACT

According to some embodiments, a system for presenting content can comprise at least one sensor; a display configured to present a graphical user interface (GUI); at least one processor in communication with the at least one sensor, the display, and memory containing instructions that, when executed, cause the at least one processor to: determining whether an accessory is detected by the at least one sensor; and in response to determining that the accessory is not detected, presenting first content on the display; or in response to determining that the accessory is detected, presenting second content on the display.

### RELATED APPLICATIONS

This application is related to and claims priority to U.S. Provisional Patent Application Ser. No. 63/377,101, entitled “SYSTEMS AND METHODS FOR A VEHICLE INTERACTIVE DISPLAY,” filed Sep. 26, 2022, and which is hereby incorporated by reference in its entirety.

### TECHNICAL FIELD

The present disclosure generally relates to mobile devices, access authorization, vehicles, and/or devices and displays processing and reacting to authorization.

### BACKGROUND

Vehicle emblems are often non-functional, decorative badges placed on a high visibility location on a vehicle. These emblems serve to advertise the manufacturer brand or distinguish between trim levels. Additionally, persons outside a vehicle have no ability to interact with a vehicle other than to speak to a driver. Such interactions take time, and it can take further time and effort if the operator and the persons have to verify identity of each other by showing documents, verifying identify, and so forth.

Improved badges and displays of vehicles may add functionality a vehicle, such as the ability to open securable compartments of the vehicle. Users who are not owners of the vehicle may gain access to securable compartments of the vehicle without compromising security.

### SUMMARY

Disclosed embodiments provide devices and methods for mobile devices, access authorization, vehicles, and/or devices and displays processing and reacting to authorization.

According to some embodiments, a system for presenting content can comprise at least one sensor; a display configured to present a graphical user interface (GUI); at least one processor in communication with the at least one sensor, the display, and memory containing instructions that, when executed, cause the at least one processor to: determining whether an accessory is detected by the at least one sensor; and in response to determining that the accessory is not detected, presenting first content on the display; or in response to determining that the accessory is detected, presenting second content on the display.

In some embodiments, the accessory can be one of: a mobile communication device, a keyfob, an RFID device, or a watch.

In some embodiments, the accessory can be in wireless communication with the at least one sensor.

In some embodiments, first content can include at least one of: an image, a video, an animation, a notification, text, or interactive user interface elements.

In some embodiments, the second content includes at least one of: an image, a video, an animation, a notification, text, or an interactive user interface.

In some embodiments, the display is external to a cabin.

According to embodiments of the present disclosure, a system for presenting content can comprise at least one sensor; a display configured to present a graphical user interface (GUI); at least one processor in communication with the at least one sensor, the display, and memory containing instructions that, when executed, cause the at least one processor to: determine whether an electrical vehicle (EV) charger is detected by the at least one sensor; and in response to determining that the EV charger is not detected, presenting first content on the display; or in response to determining that the EV charger is detected, presenting second content on the display.

In some embodiments, the charger can be in wireless communication with the at least one sensor.

In some embodiments, first content can include at least one of: an image, a video, an animation, a notification, text, or interactive user interface elements.

In some embodiments, the second content can include at least one of: an image, a video, an animation, a notification, text, or interactive user interface elements.

In some embodiments, the display is external to a cabin.

According to embodiments of the present disclosure, a method for presenting content can comprise determining whether an accessory is detected by the at least one sensor; and in response to determining that the accessory is not detected, presenting first content on a display; or in response to determining that the accessory is detected, presenting second content on the display.

In some embodiments, the accessory is one of: a mobile communication device, a keyfob, an RFID device, or a watch.

In some embodiments, the accessory is in wireless communication with the at least one sensor.

In some embodiments, first content can include at least one of: an image, a video, an animation, a notification, text, or interactive user interface elements.

In some embodiments, the second content can include at least one of: an image, a video, an animation, a notification, text, or interactive user interface elements.

In some embodiments, the display is external to a cabin.

According to embodiments of the present disclosure, a system for presenting content can comprise: a first accessory; a second accessory; and a vehicle including: at least one sensor; a display configured to present a graphical user interface (GUI); a first securable compartment; a second securable compartment; and at least one processor in communication with the at least one sensor, the display, and memory containing instructions that, when executed, cause the at least one processor to: determine that the first accessory is detected by the at least one sensor; and presenting first content and opening the first securable compartment; or determine that the second accessory is detected by the at least one sensor; and presenting second content and opening the second securable compartment.

In some embodiments, the accessory can be one of: a mobile communication device, a keyfob, an RFID device, or a watch.

In some embodiments, the accessory can be in wireless communication with the at least one sensor.

In some embodiments, first content can include at least one of: an image, a video, an animation, a notification, text, or interactive user interface elements.

In some embodiments, the second content can include at least one of: an image, a video, an animation, a notification, text, or interactive user interface elements.

In some embodiments, the display is external to a cabin.

According to embodiments of the present disclosure, a system for keyless vehicle compartment access can comprise: a vehicle including: at least one sensor; a display configured to present a graphical user interface (GUI); a first securable compartment; a second securable compartment; and at least one processor in communication with the at least one sensor, the display, and memory containing instructions that, when executed, cause the at least one processor to: present, on the display, a first authentication screen; receive a first indication of a successful authentication attempt; open the first securable compartment; present on the display, a second authentication screen; receive a second indication of a successful authentication attempt; and open the second securable compartment.

In some embodiments, the first authentication screen includes at least one of: an image, a video, an animation, a notification, text, lock screen, QR code, keypad, password entry screen, or other interactive user interface elements.

In some embodiments, the second authentication screen includes at least one of: an image, a video, an animation, a notification, text, lock screen, QR code, keypad, password entry screen, or other interactive user interface elements.

In some embodiments, the display is internal or external to a cabin or one display is external and another display is internal.

### BRIEF DESCRIPTION OF THE DRAWINGS

The accompanying drawings, which are incorporated in and constitute a part of this specification, illustrate several examples, and, together with the description, serve to explain the disclosed principles.

FIG. 1 is a schematic diagram illustrating an exemplary system environment used to present content on a display, consistent with disclosed embodiments.

FIG. 2 is an illustration of an exemplary locations of the display on a vehicle, consistent with the present disclosure.

FIGS. 3A-3J are illustrations of example content that can be presented, consistent with the present disclosure.

FIG. 4 is a flowchart of an exemplary method for keyless access to a securable compartment, consistent with the present disclosure.

### DETAILED DESCRIPTION

Reference will now be made in detail to exemplary embodiments, examples of which are illustrated in the accompanying drawings and disclosed herein. Wherever convenient, the same reference numbers will be used throughout the drawings to refer to the same or like parts. For ease of discussion, the present disclosure may describe embodiments in the context of interacting with a vehicle for authentication or to retrieve objects from the vehicle for a delivery. It is to be understood, however, that disclosed embodiments are not limited to delivery applications. Rather, the disclosed devices and methods are applicable to vehicle and device authentication, charging stations, passenger pickup, and for many other purposes and, in fact, are not limited to any particular industry or field.

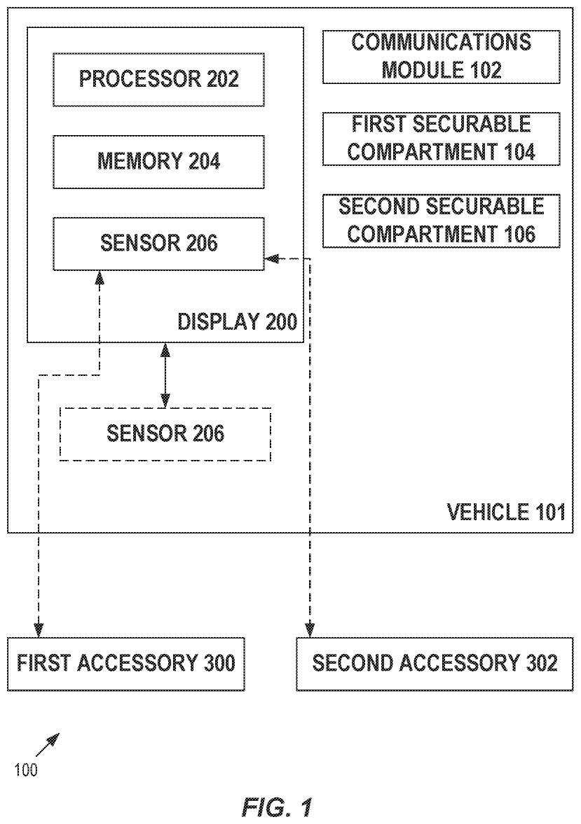

FIG. 1 is a schematic diagram illustrating an exemplary system environment used to present content on a display, consistent with disclosed examples. The components and arrangements shown in FIG. 1 are not intended to limit the disclosed examples, as the components used to implement the disclosed processes and features may vary.

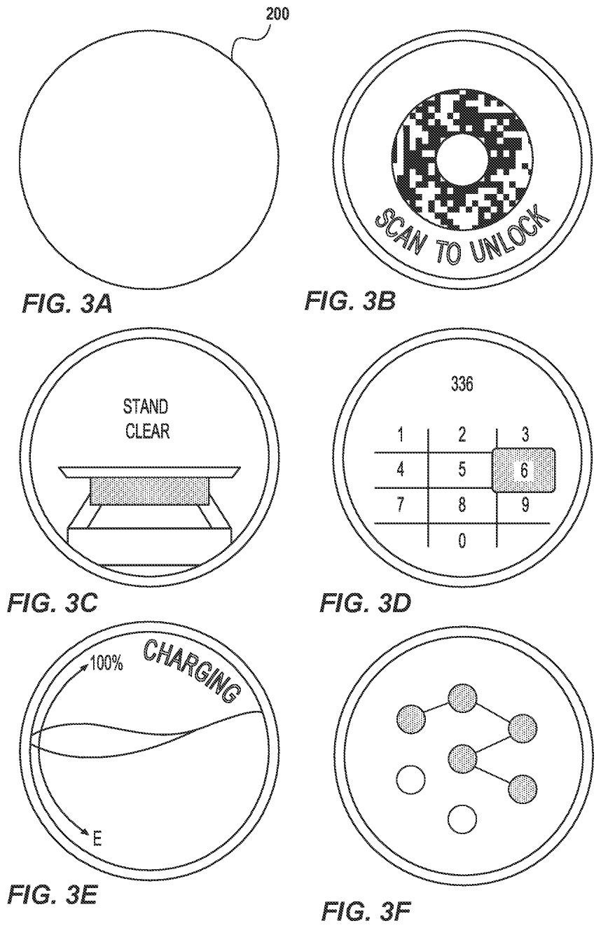

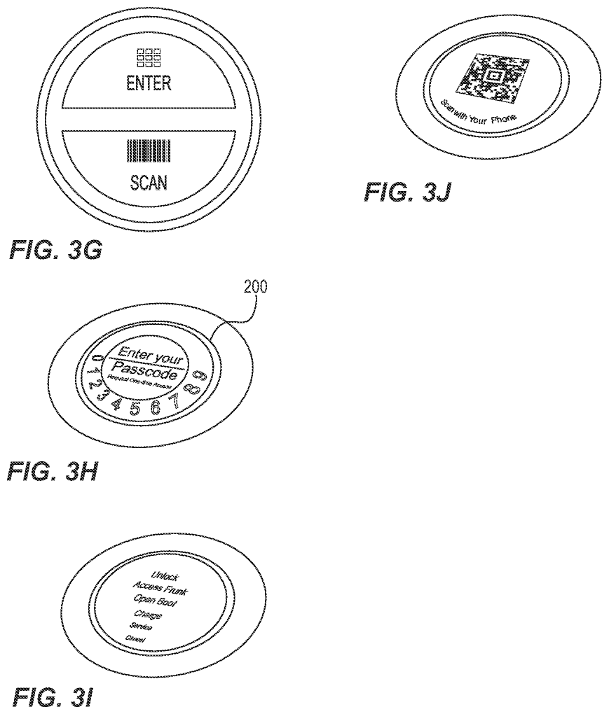

In accordance with the disclosed embodiments, system 100 may include a first accessory 300, a system 100 may include a communications module 102, a first securable compartment 104, a second securable compartment 106, and display 200. In some embodiments, the system 100 may include a second accessory 302. In some embodiments, the display 200 may include at least one processor 202, and memory 204. In some embodiments, display 200 may include sensor 206. In some embodiments, vehicle 101 may include sensor 206. Server 111 is discussed in additional detail with respect to FIG. 3, below.

Communications module 102 may be, for example, a secured or unsecured network and may be implemented as, for example, the internet, a wired Wide Area Network (WAN), a wired Local Area Network (LAN), a wireless LAN (e.g., IEEE 802.11, Bluetooth, etc.), a wireless WAN (e.g., WiMAX), RFID, or the like.

The first securable compartment 104 may be a compartment in a vehicle that is securable, for example, a glovebox, a trunk, a “frunk” (front-trunk), a cabin, a fuel port, or an EV charging port. As used herein, “securable” refers to a compartment that includes at least one lid configurable to be locked and/or unlocked. Locking and unlocking may occur for example, via a lock, a clasp, or an actuator.

The second securable compartment 106 may be a compartment in a vehicle that is securable, for example, a glovebox, a trunk, a “frunk” (front-trunk), a cabin, a fuel port, or an EV charging port.

Display 200 may be, for example, a liquid crystal display (LCD), a light emitting diode screen (LED), an organic light emitting diode screens (OLED), a touch screen, or other known display screens. Display 200 may be configured to present a graphical user interface (GUI). Display 200 may display various kinds of content, to be described below. Display 200 may be protected by a cover comprising one or more of a transparent or translucent housing, a screen cover, a plastic cover, or similar, for example, to protect display 200 from impacts, weather, or accumulation of particulate. The cover may comprise a digitizer capable of receiving instructions, for example, from a user's finger. In some embodiments, display 200 may include a light behind a screen image.

Display 200 may comprise a display capable of showing a badge emblem of the vehicle. The badge emblem may allow persons outside a vehicle to readily identify a vehicle's manufacturer. Display 200 may comprise a display capable of changing when a person interacts with it. Example of interactions may include locking a vehicle, unlocking the vehicle, locking a compartment, unlocking a compartment, alerting a vehicle operator or driver to a person's presence, inserting an authentication appropriate for an individual (e.g., a pin, a pattern), or other interactions disclosed herein.

Display 200 may be a display external to a cabin, for example, for a user to access from outside a vehicle. The user may interact with display 200 and/or a sensor (e.g., sensor 206) to access the vehicle, alert a driver of a vehicle of the user's presence or authentication (e.g., as a passenger, as a person expecting a delivery, etc.), and/or to open a compartment of the vehicle.

The driver may be alerted via a mobile device (e.g., a text, an application alert, an application user interface) or through an internal display (e.g., for an operator of a vehicle) that is part of the vehicle. The internal display may comprise a touch screen.

The at least one processor 202 may be one or more known or custom processing devices designed to perform functions of the disclosed methods, such as a single core or multiple core processors capable of executing parallel processes simultaneously. For example, processor 202 may be configured with virtual processing technologies. In certain embodiments, processor 202 may use logical processors to simultaneously execute and control multiple processors. Processor 202 may be implement virtual machine, or other known technologies to provide the ability to execute, control, run, manipulate, store, etc. multiple software processes, applications, programs, etc. In another embodiment, processor 202 may include multiple-core processor arrangement (e.g., dual core, quad core, etc.) configured to provide parallel processing functionalities to allow for execution multiple processes simultaneously. One of ordinary skill in the art would understand that other types of processor arrangements could be implemented that provide for the capabilities disclosed herein.

Memory 204 may include one or more memory devices that store data and instructions used to perform one or more features of the disclosed embodiments. For example, memory 204 may represent a tangible and non-transitory computer-readable medium having stored therein computer programs, sets of instructions, code, or data to be executed by processor 202. Memory 204 may include, for example, a removable memory chip (e.g., EPROM, RAM, ROM, DRAM, EE PROM, flash memory devices, or other volatile or non-volatile memory devices) or other removable storage units that allow instructions and data to be accessed by processor 202.

Memory 204 may also include instructions that, when executed by processor 202, perform operations consistent with the functionalities disclosed herein. Methods, systems, and devices consistent with disclosed embodiments are not limited to separate programs or computers configured to perform dedicated tasks. For example, memory 204 may include one or more programs to perform one or more functions of the disclosed embodiments. Moreover, processor 202 may execute one or more programs located remotely from system 100.

Sensor 206 may include at least one of: a proximity sensor, a wireless LAN (e.g., IEEE 802.11, Bluetooth, etc.), a wireless WAN (e.g., WiMAX), RFID, any sensor capable of detecting or pairing with an accessory, or any sensor capable of detecting an object within a distance threshold. In some embodiments, sensor 206 may include a wireless transmitter. In some embodiments, sensor 206 may include a wireless receiver.

First accessory 300 may be a tablet, smart phone, multifunctional watch, a keyfob, or any suitable accessory associated with a vehicle owner, renter, or passenger. In some embodiments, the first accessory 300 may be an EV charger or an EV charging cable.

Second accessory 302 may be a tablet, smart phone, multifunctional watch, a keyfob, or any suitable accessory associated with a vehicle owner, renter, or passenger. In some embodiments, the second accessory 302 may be an EV charger or an EV charging cable.

Each component in system 100 may communicate bi-directionally with other components of system 100 either over a network (not shown) or through one or more direct communication links.

Other components known to one of ordinary skill in the art may be included in system 100 to process, transmit, provide and receive information consistent with the disclosed examples. In addition, although not shown in FIG. 1, components of system 100 may communicate each other through direct communications, rather than through a network (not shown).

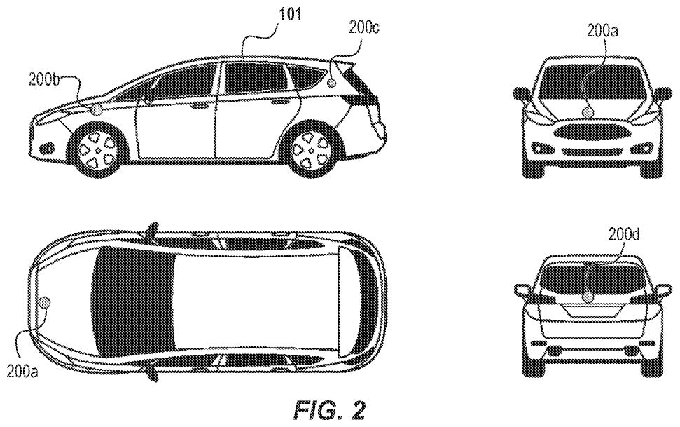

FIG. 2 is an illustration of an exemplary locations of the display on a vehicle, consistent with the present disclosure. Vehicle 101 may include one or more displays 200a-200d, each of which may be substantially similar to display 200. In some embodiments, the one or more display 200a-200d may be in communication with one another.

FIGS. 3A-3J are illustrations of exemplary content, consistent with the present disclosure. Content may include at least one of: an image, a video, an animation, a notification, text, or interactive user interface elements. In some embodiments, FIG. 3A may be default content presented by display 200 in a “default”, “idle” or “away” state. In some embodiments, FIGS. 3B, 3D, 3E, 3H, and 3J, may be presented by display 200 to authenticate a user, and may be referred to as authentication content. In some embodiments, authentication content may be presented to a user before allowing the user to open a securable compartment. In some embodiments, FIG. 3C may be notification content that may be presented using display 200 to the user upon successful authentication or before the vehicle 101 performs an automated action. In some embodiments, FIG. 3E may be battery status or charging status content, and presented by display 200 upon detecting an EV charger, EV charging cable, or an accessory. In some embodiments, FIGS. 31 and 3G may be user selectable content that may be presented using display 200 to the user. The user selectable content may be presented before or after successful authentication.

In some embodiments, a securable compartment may open when an accessory or EV charger is detected. For example, the securable compartment may unlock or an actuator may open the securable compartment. In some embodiments, the securable compartment may close when an accessory is no longer sensed within a threshold distance, when a user presses on the compartment, when a user inputs instructions via a user interface, a mobile device, or the display, or when a vehicle operator inputs instructions via a user interface, a mobile device, or the display. For example, the securable compartment may lock or an actuator may close the securable compartment.

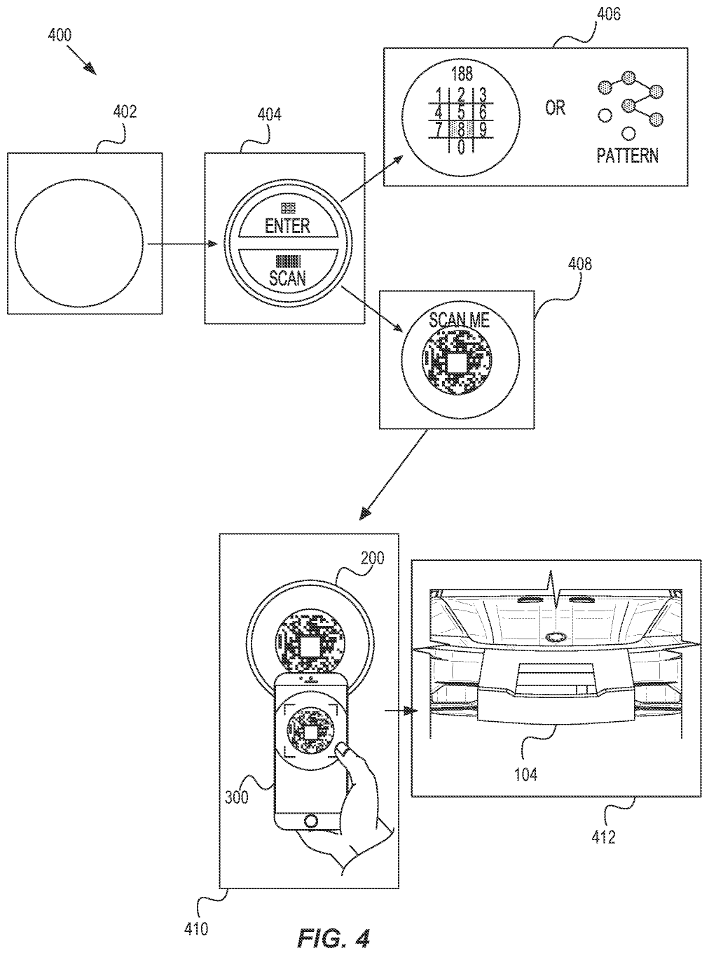

FIG. 4 is a flowchart of an exemplary method for keyless access to a securable compartment, consistent with the present disclosure. For discussion purposes, the exemplary methods discussed in this disclosure (including the method 400) are described as performed by display 200. In some embodiments, however first and/or second accessory 300, 302 may perform one or more disclosed method steps. In some examples, different components of the system 100 may perform various steps of the methods in a distributed-computing configuration.

In step 402, display 200 may be in a default state, as discussed earlier, and awaiting user input or detection of an accessory.

In step 404, upon detecting an accessory or a user input, display 200 may present user selectable content, as discussed earlier. In some embodiments, display 200 may await a selection by the user of the content. In some embodiments, display 200 may receive an indication of a selection of the content from the accessory 300. Depending on the received selection, method 400 may proceed to step 406 or step 408.

In step 406, display 200 may present authentication content. Authentication may be successfully completed entering a password or pattern that matches a stored user-provided password or pattern. Upon successful completion of the authentication, display 200 may present notification content, user selectable content, or other appropriate content to the user. In some embodiments, after successful authentication, one or more securable compartments may be accessible or opened by the user. In some embodiments, the display 200 may return to step 402, and may successfully authenticate a second user upon receiving a second password or pattern that matches a second stored user-provided password or pattern. After successful authentication, a second one or more securable compartments may be accessible or opened by the second user.

In step 408, display 200 may present a computer-generated authentication content, for example, a QR code or a bar code.

In step 410, authentication may be successfully completed using an accessory 300 capable of reading a computer-generated code to authenticate the user. Upon successful completion of the authentication, display 200 may present notification content, user selectable content, or other appropriate content to the user.

In step 412, in some embodiments, after successful authentication, one or more securable compartments 104, 106 may be accessible or opened by the user. In some embodiments, the display 200 may return to step 402, and may successfully authenticate a second user using an accessory 300 capable of reading a computer-generated code. After successful authentication, a second one or more securable compartments 104, 106 may be accessible or opened by the second user.

Computer programs or instructions based on the written description and methods of this specification are within the skill of a software developer. The various programs or program modules can be created using a variety of programming techniques. For example, program sections or program modules can be designed by means of python, Java, C, C++, assembly language, or any such programming languages. One or more of such software sections or modules can be integrated into a computer system, non-transitory computer readable media, or existing communications software.

Moreover, while illustrative embodiments have been described herein, the scope includes any and all embodiments having equivalent elements, modifications, omissions, combinations (e.g., of aspect across various embodiments), adaptions or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that he specification and examples be considered as exemplary only, with a true scope and spirit being indicated by the following claims and their full scope of equivalents.

What is claimed is:

1. A system for presenting content comprising:
at least one sensor of a vehicle;
a display of the vehicle configured to present a graphical user interface (GUI) outside of the vehicle;
at least one processor in communication with the at least one sensor, the display, and memory containing instructions that, when executed, cause the at least one processor to:
determine whether a component associated with the vehicle is detected by the at least one sensor; and
in response to determining that the component is not detected, present first content on the display; and
in response to determining that the component is detected, present second content on the display.

2. The system of claim 1, wherein the component comprises an accessory associated with a vehicle operator, and wherein the accessory is one of: a mobile communication device, a keyfob, an RFID device, or a watch.

3. The system of claim 1, wherein the component comprises an electrical vehicle (EV) charger.

4. The system of claim 1, wherein the component is in wireless communication with the at least one sensor.

5. The system of claim 1, wherein first content includes at least one of: an image, a video, an animation, a notification, text, or an interactive user interface.

6. The system of claim 1, wherein the second content includes at least one of: an image, a video, an animation, a notification, text, an interactive user interface.

7. The system of claim 1, wherein the display is external to a cabin of the vehicle.

8. The system of claim 1, wherein the at least one sensor comprises one or more of a proximity sensor, a wireless Local Area Network (LAN) device, a wireless Wide Area Network (WAN) device, and Radio Frequency Identification (RFID) device.

9. A system for vehicle compartment access comprising:
a first accessory;
a second accessory; and
a vehicle including:
at least one sensor;
a display configured to present a graphical user interface (GUI);
a first securable compartment;
a second securable compartment; and
at least one processor in communication with the at least one sensor, the display, and memory containing instructions that, when executed, cause the at least one processor to:
determine that the first accessory is detected by the at least one sensor;
in response to determining that the first accessory is detected, present first content and opening the first securable compartment;
determine that the second accessory is detected by the at least one sensor; and
in response to determining that the second accessory is detected, presenting second content and opening the second securable compartment.

10. The system of claim 9, wherein the accessory is one of: a mobile communication device, a keyfob, an RFID device, or a watch.

11. The system of claim 9, wherein the accessory is in wireless communication with the at least one sensor.

12. The system of claim 9, wherein first content includes at least one of: an image, a video, an animation, a notification, text, or interactive user interface elements.

13. The system of claim 9, wherein the second content includes at least one of: an image, a video, an animation, a notification, text, or interactive user interface elements.

14. The system of claim 9, wherein the display is external to a cabin of the vehicle.

15. The system of claim 9, wherein the at least one sensor comprises one or more of a proximity sensor, a wireless Local Area Network (LAN) device, a wireless Wide Area Network (WAN) device, and Radio Frequency Identification (RFID) device.

16. A system for keyless vehicle compartment access comprising:
a vehicle including:
at least one sensor;
a display configured to present a graphical user interface (GUI);
a first securable compartment;
a second securable compartment; and
at least one processor in communication with the at least one sensor, the display, and memory containing instructions that, when executed, cause the at least one processor to:
present, on the display, a first authentication screen;
receive a first indication of a successful authentication attempt; open the first securable compartment;
present, on the display, a second authentication screen;
receive a second indication of a successful authentication attempt; and open the second securable compartment.

17. The system of claim 16, wherein the first authentication screen includes at least one of: an image, a video, an animation, a notification, text, lock screen, QR code, keypad, password entry screen, or other interactive user interface elements.

18. The system of claim 16, wherein the second authentication screen includes at least one of: an image, a video, an animation, a notification, text, lock screen, QR code, keypad, password entry screen, or other interactive user interface elements.

19. The system of claim 16, wherein the display is external to a cabin of the vehicle.

20. The system of claim 16, wherein the at least one sensor comprises one or more of a proximity sensor, a wireless Local Area Network (LAN) device, a wireless Wide Area Network (WAN) device, and Radio Frequency Identification (RFID) device.
